(19) United States
(12) Patent Application Publication
(10) Pub. No.: US 2021/0379625 A1
(43) Pub. Date: Dec. 9, 2021

(54) CLEANSER DISPENSER AND APPLICATOR SYSTEM

(71) Applicant: You Body Care LLC, Yardley, PA (US)

(72) Inventors: Michele C. DUGGAN, Middletown, NY (US); Richard S. CHOMIK, Newtown, PA (US); Jason PHILLIPS, Cincinnati, OH (US); Alicia EVANS, Loveland, OH (US)

(73) Assignee: You Body Care LLC, Yardley, PA (US)

(21) Appl. No.: 16/894,013

(22) Filed: Jun. 5, 2020

(51) Int. Cl. B08B 1/00; B08B 3/08; A47K 7/03

(52) U.S. Cl. CPC B08B 1/001; A47K 7/03; B08B 3/08

(57) ABSTRACT

Cleanser dispenser and applicator systems are provided and include a dispenser having an interior and a dispenser opening, a porous barrier disposed within the interior and comprising a meshing sized to prevent or inhibit viscous liquid from passing through the barrier, a removable lid for introducing cleanser into dispenser and through the porous barrier is disposed across the dispenser opening, an applicator body connected to the dispenser such that the dispenser opening is disposed between the interior and the applicator body and provides fluid communication from the interior to the applicator body, a seal operable for opening and closing the dispenser opening such that, when the dispenser opening is opened, the interior of the dispenser fluidly communicates a cleanser mixture to the sponge body, and an activation button for operating the seal.

The present disclosure generally relates to a cleansing accessory that is designed to provide improved cleaning, while also providing a cleanser filling and dispensing mechanism which allows for ease of refill and avoids clogging and other negative aspects of traditional liquid or gel-based cleanser dispensers. The dispenser and sponge systems disclosed herein comprise at least one dispenser having a built-in cleanser dispenser mechanism in fluid communication with a sponge or other cleaning surface for providing and/or applying a dispensed mixture of cleanser and/or cleanser foam onto a surface to be cleaned.

### BACKGROUND

A combined cleanser dispenser and sponge system is known, which comprises a sponge body having a cavity in fluid communication with an attached refillable cleanser dispenser/container by way of an opening mechanism which sealingly connects the dispenser and the cavity. The container is refillable with a liquid cleanser or bath gel by way of a closeable port. The drawback of such a system lies in its reliance on liquid cleanser or bath gel which are relatively viscous and therefore tend to clog or gum up the opening mechanism and/or the refill port either during use, or by way of dried residue after use.

### SUMMARY OF THE DISCLOSURE

Accordingly, the present invention is intended to overcome such drawbacks and to provide a cleanser dispenser and applicator system which is convenient to refill and to use, while avoiding the clogging or gumming associated with the prior art system. In particular, the inventive system is specifically structured to be used in combination with a powdered cleanser, and specifically to have a structure which prevents or reduces clogging of the openings and opening mechanism connecting the applicator cavity and the cleanser dispenser. In order to achieve these aspects of the invention, a porous barrier is located between the cleanser refill opening and interior of the cleanser dispenser. The pore size of the barrier is selected to also allow cleanser powder to pass through in a dry state to the interior of the dispenser, while being sufficiently small to prevent, inhibit and/or discourage the use of more viscous cleansers such as liquid or gel cleansers.

In addition, the sealable, openable dispensing port in fluid communication between the dispenser interior and the sponge cavity has a relatively small opening size, which is selected to control the flow of cleanser, comprising liquid, preferably water, and the dissolved or suspended cleanser powder, having a relatively low viscosity. The low viscosity allows for ease of flow into the applicator cavity, such as by gravity, but also reduces the susceptibility to clogging of the port and the opening mechanism, as it often the case with higher viscosity cleanser products or refills, for example, in the form of a viscous liquid, gel, lotion or creme. The relatively fine porosity of the porous barrier acts to allow the powdered cleanser, either in dry form or dissolved or suspended in liquid to pass therethrough into the dispenser interior, while it deters the use of a high viscosity liquid cleanser with the system. (“liquid cleanser”, as used in the application, refers to relatively high viscosity liquids, gels, lotions, cremes of the like, generally having a viscosity of greater than 1,000 cps). Such undesirable liquid cleanser refill would be incompatible with the small port opening to the applicator cavity. Therefore, the novel structure of the inventive system has the advantage of not only improved ease of use, improved performance and decrease in clogging and gumming; but also acts to deter or prevent the use of incompatible cleanser refills which would have a deleterious effect on the functioning and operability of the system.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a dispenser and applicator system, according to one or more examples of the disclosure.

FIG. 2 is a perspective view of a dispenser and a mounting ring, according to one or more examples of the disclosure.

FIG. 3 is a perspective view of a bottom of the dispenser and the mounting ring shown in FIG. 2, according to one or more examples of the disclosure.

FIG. 4 is a perspective view of a top of a dispenser with an accessible interior, according to one or more examples of the disclosure.

FIG. 5 is a perspective view of a top of a lid or door, according to one or more examples of the disclosure.

FIG. 6 is a perspective view of a bottom of the lid shown in FIG. 5, according to one or more examples of the disclosure.

FIG. 7 is a perspective view of a bottom of a mounting ring, according to one or more examples of the disclosure.

FIG. 8 is a perspective view of the top of the mounting ring shown in FIG. 7, according to one or more examples of the disclosure.

FIG. 9 is a cross-sectional view of a mounting ring engaging a bottom of a dispenser, according to one or more examples of the disclosure.

FIG. 10 is a cross-sectional view of a dispense door mechanism in a first or closed position, according to one or more examples of the disclosure.

FIG. 11 is a cross-sectional view of a dispense door mechanism in a second or opened position, according to one or more examples of the disclosure.

FIG. 12 is perspective view of a formulation being added to a dispenser, according to one or more examples of the disclosure.

FIG. 13 is a cross-sectional view of a dispenser, formulation, and a mesh basket, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

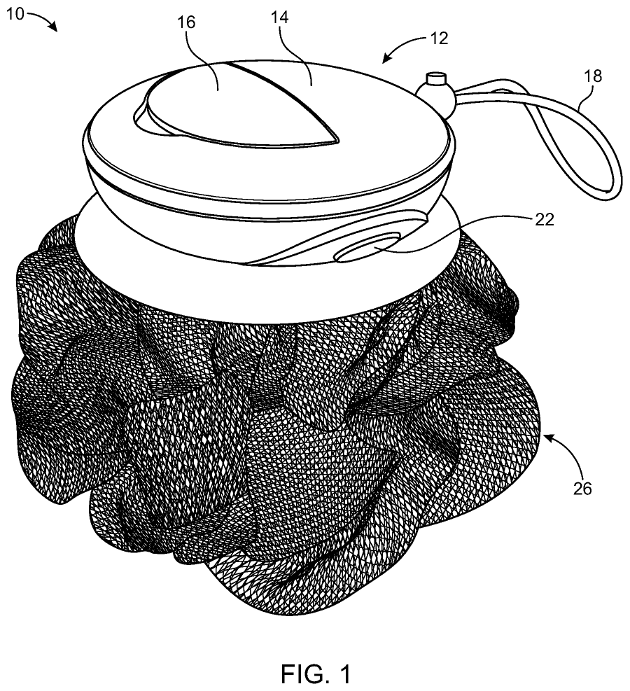

In FIG. 1, a dispenser and cleanser system 10 (hereinafter “system 10”) is provided. The system 10 may comprise a dispenser 12 having a housing body 14, a openable and sealable door and/or lid 16 (hereinafter “lid 16”), optionally lanyard, cord, and/or strap 18 (hereinafter “strap 18”), and/or a dispense door mechanism 20 (hereinafter “mechanism 20”) having an activation button 22 (hereinafter “button 22”) disposed on the housing body 14. Opposite to the lid 16 is a mounting mechanism, for example a ring 24 having an applicator body 26 connected thereto that engages the housing body 14 of the dispenser 12 to connect, attach, and/or fasten the applicator 26 to the dispenser 12. In general, the dispenser 12 may have a semi-circular or semi-spherical shape to facilitate easy and/or comfortable holding in a hand of the user, and may be formed with an integral handle, or a detachable handle.

In embodiments, the applicator, herein shown as a sponge 26 may be have at least one cavity (not shown in the drawings) therein on a first side adjacent to the dispenser 12. In an embodiment, the at least one cavity may be disposed within a portion of the sponge 26. Additionally, the sponge 26 may comprise a periphery surrounding and defining cavity. The applicator 26 may be any known porous or open-cell material or product which allows for the receiving of a cleanser liquid and application therefrom to a surface to be cleaned, for example a sponge. Thus, the system of the invention may be a bath or shower sponge for personal use, or a system for cleansing of soft or hard surfaces of a household, commercial or industrial nature. The sponge 26 may be an open-cell sponge with a net surrounding an outside surface of the sponge 26. Moreover, the net may be of a polymeric-based material. In the specification, the term ‘applicator’ and ‘sponge’ may be used interchangeably.

The dispenser 12 comprises a built-in cleanser dispenser in fluid communication with the sponge 26 for providing and/or applying a dispensed resulting mixture which may comprise cleanser and/or cleanser foam onto a surface, such as skin. The built-in cleanser dispenser is activatable by the pressing or moving the button 22 of the mechanism 20. Utilizing the system 10 to cleanse the surface is easy, more efficient, and/or more effective than standard cleansing methods. In embodiments, the button 22 may be a spring-loaded release button located at or disposed on the housing body 14 that may be used to release or dispense the resulting mixture onto the sponge 26 and/or into the cavity or open-cells of the sponge 26.

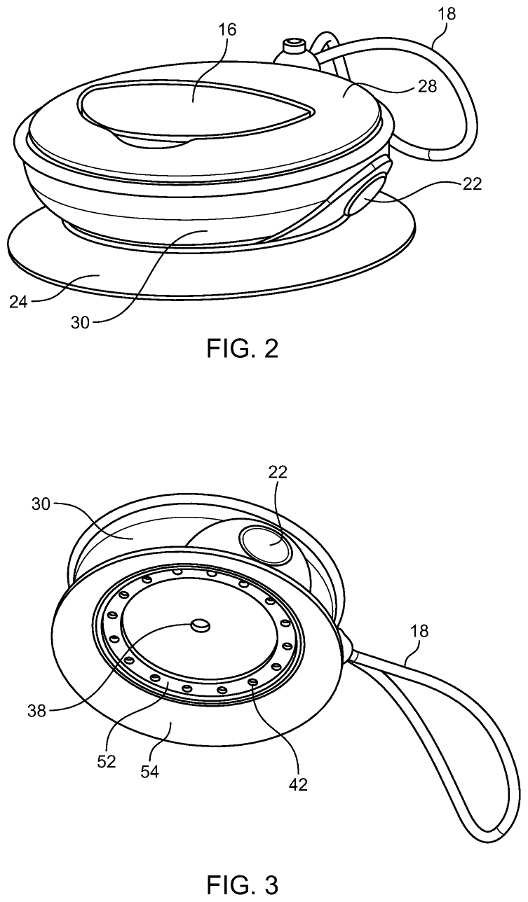

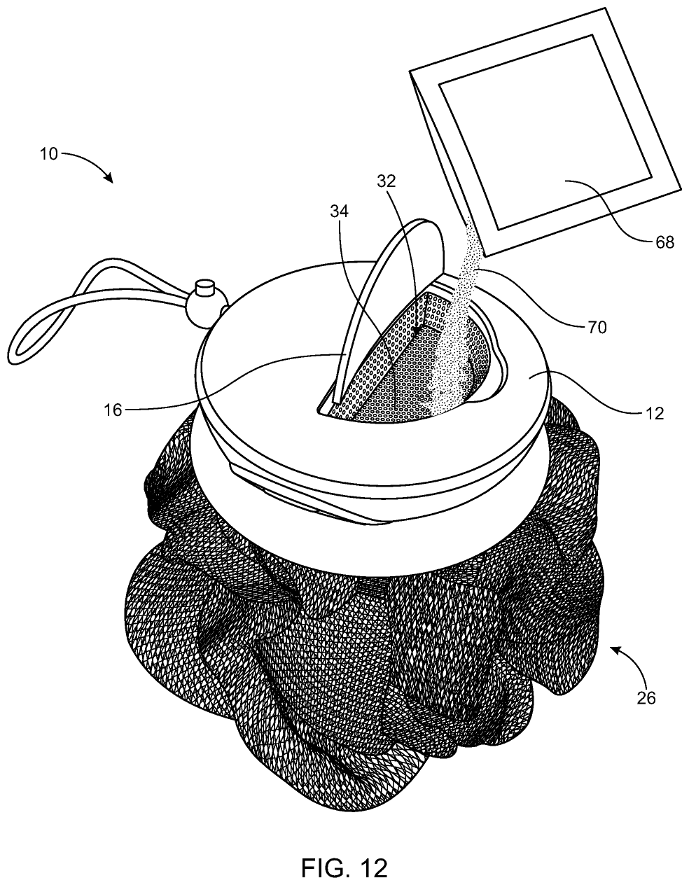

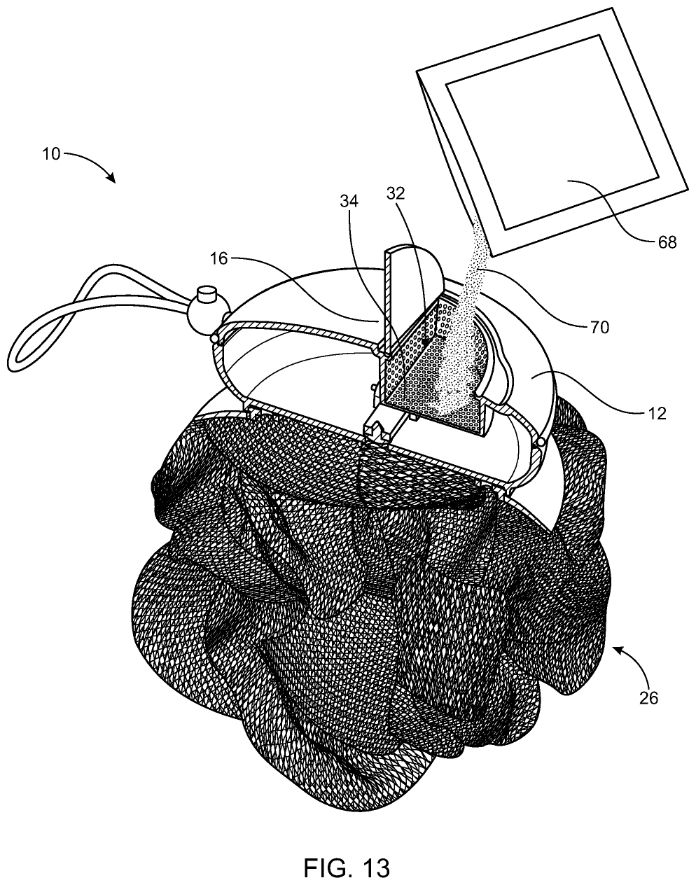

As shown in FIG. 2, the housing body 14 of the dispenser 12 comprises a top housing portion 28 and an opposite bottom housing portion 30 that encircle that define an interior 32 of the dispenser 12. The interior 32 may be accessible by removing and/or opening the lid 16 such that compatible cleansing formulations (hereinafter “cleanser formulation”) may be received and/or disposed within the interior 32 of the dispenser 12. As a result, the cleanser formulation may be initially received and/or disposed on or within a porous barrier, preferably a mesh basket 34 (hereinafter “basket 34”) projecting into the interior 32 of the dispenser 12, as shown in more detail in FIGS. 12 and 13. The porous barrier may also be a substantially planar barrier which essentially reaches across the opening to the interior 32 of the dispenser. The porous barrier may be formed to match the curvature of the dispenser, or may be of a concave shape. While a rigid or semi-rigid mesh basket is illustrated herein as the porous barrier, it is understood that any acceptable porous retaining structure may be used to achieve the same function, namely, as set forth in more detail below, the passing through of powdered cleanser formulation either in dry form or after it has been dissolved or suspended in low-viscosity liquid added through the lid to the interior of the dispenser; and the prevention or inhibition of the use of incompatible viscous cleanser refills such as liquid. For example, a pliable net or filter. The pore size of the porous barrier is selected to prevent or inhibit passage therethrough of highly viscous liquid cleansers, i.e. those having a viscosity of greater than 1,000 cps at 20 degrees C., while permitting the passage of dry cleanser powder as well as the low viscosity (about 1 cps to less than 1000 cps, preferably about 50 to about 500 cps, more preferably about 100 to about 400 cps, and most preferably about 200 to about 300 cps) solution or suspension of the dry cleanser powder in liquid. In this regard, the average pore size of the porous barrier should be between about 25 microns and about 500 microns, preferably between about 100 and about 400 microns and more preferably between about 200 and about 300 microns. Optionally, the porous barrier may be removable for cleaning and/or replaceable with a fresh component. After the cleanser formulation is received or disposed within the interior 32 and/or the basket 34, an amount of a liquid, preferably water, may be added to the interior 32 of the dispenser 12 and/or the lid 16 may added or closed such that the interior 32 of the housing body 14 is a substantially closed system and/or not accessible from the environment surrounding the dispenser 12. Liquid is added to a level within the interior 32 which is preferably above at least a portion of the basket 34 such that cleanser formulation may dissolve into the liquid. Alternatively, any volume of liquid may be added so long as it is sufficient to dissolve or have suspended therein the amount of cleanser formulation added. In either case, agitation of the dispenser will assist in dissolution or suspension of the cleanser formulation. The cleanser and/or cleanser foam for dispensing from the housing body 14 may be a mixture of cleanser formulation and the liquid that is configured or formulated to cleanse surfaces contacted by the sponge 26.

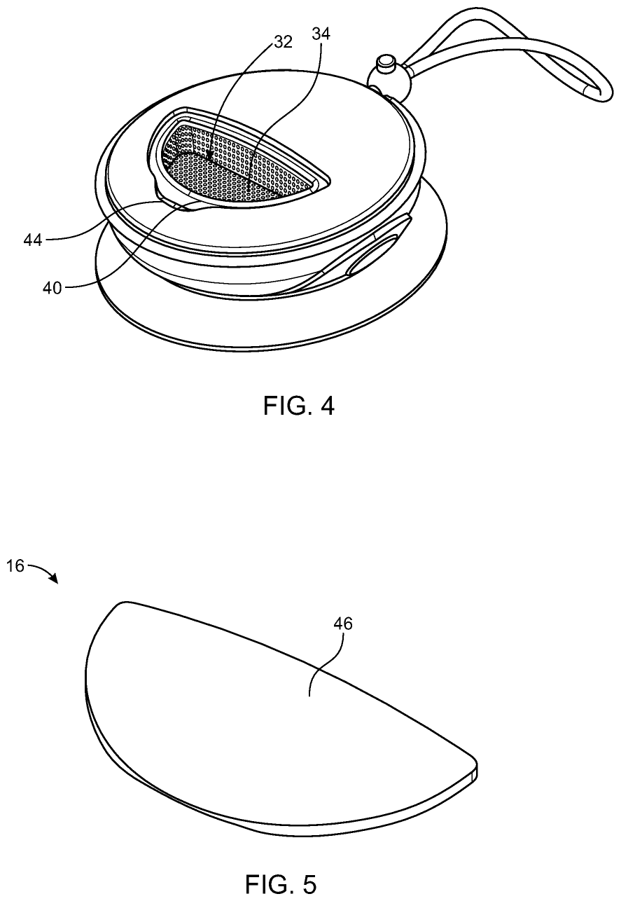

In embodiments, the housing body 14 further comprises a receiving ring 36 disposed and/or provided on the bottom housing portion 30 which may be sized and/or configured to receive the mounting ring 24 having the sponge 26 connected thereto as shown in FIGS. 9-11. As a result of inserting the mounting ring 24 into the receiving ring 36 of the housing body 14, the mounting ring 24 may snap-fit into the housing body 14 for use by a user while showering and/or bathing. The housing body 14 may also further comprise a dispenser door or opening 38 (hereinafter “dispenser opening 38”) disposed and/or provided on the bottom housing portion 30 which, when opened or activated, may dispense at least a portion of the resulting mixture into or onto the sponge 26 as shown in FIGS. 3, 10 and 11. Moreover, the housing body 14 may further comprise a door seal 40 disposed and/or provided on the top housing portion 28 and/or a bottom surface of the lid 16 for firmly sealing and/or securing the lid 16 to the top housing portion 28 as shown in FIG. 4. As a result of the door seal 40, the lid 16 and the housing body 14 may sealed in a liquid- or fluid-proof manner. In other words, the door seal 40 may prevent the liquid and/or the resulting mixture from leaving the interior 32 of the dispenser. In an embodiment, the dispenser opening 38 may have a diameter of about 2.5 to about 10.0 mm, preferably about 5.0 inches to about 7.5 mm, even more preferably about 5.5 mm to about 7.0 mm, and most preferably about 6.25 mm. The size of the dispenser opening 38 is selected so as to achieve two key aspects of the invention: as the resulting cleanser from the liquid and cleanser formulation is a relatively low viscosity and free-flowing, it must be within a range which can permit but also restrict and control the flow volume of the cleanser into the sponge cavity so as to let through only a desirable amount; and to be sufficiently small so as to substantially and/or effectively prevent or inhibit the passing through of a more viscous cleanser type such as liquid cleanser or gel cleanser.

As shown in FIG. 3, the dispenser opening 38 is provided on or in the bottom housing portion 30 and/or directly faces or opens towards the sponge 26 when the mounting ring 24 and the sponge 26 have been connected to the housing body 14. As a result, the resulting mixture exiting the dispenser opening 38, when, or immediately after, the button 22 is activated or pushed, directly contacts at least a portion of the sponge 26 adjacent to the dispenser opening 38.

The mounting or connection of the sponge body to the dispenser body may be accomplished by known methods. In one embodiment, the mounting ring 24 may have a plurality of holes, openings, and/or perforations 42 (hereinafter “perforations 42”) provided and/or disposed at or around one or more portions of the mounting ring 24 as shown in FIG. 3. The perforations 42 of the mounting ring 24 may be sized, shaped, configured, and/or adapted to connect, attach, fasten, and/or secure the sponge 26 directly to the mounting ring 24. In an embodiment, stitching extending through the perforations 42 may directly connect, attach, and/or fasten the sponge 26 directly to the mounting ring 24. In embodiments, the sponge 26 may be a replaceable sponge that may be changed to a new or different sponge.

FIG. 4 shows the top housing portion 28 after the lid 16 has been removed therefrom such that the interior 32 of the housing body 14 is accessible for placing the cleanser formulation within the interior 32 of the dispenser 12. The basket 34 is disposed within the interior 32 of the housing body 14 and is sized, shaped, configured, and/or adapted such that the basket 34 provides a selective barrier to the interior 32. As a result, the basket 34 prevents or inhibits a high viscosity cleanser from entering into the interior 32 while permitting the passing of a dry soap powder or low viscosity cleanser formulation. This acts to protect the system from gumming up and/or clogging, in particular as to components of the mechanism 20 and/or the dispenser opening 38. In embodiments, while the basket 34 may be disposed to project within the interior 32 of the dispenser 12, the basket may instead be a substantially planar porous barrier surface across the dispenser opening 38.

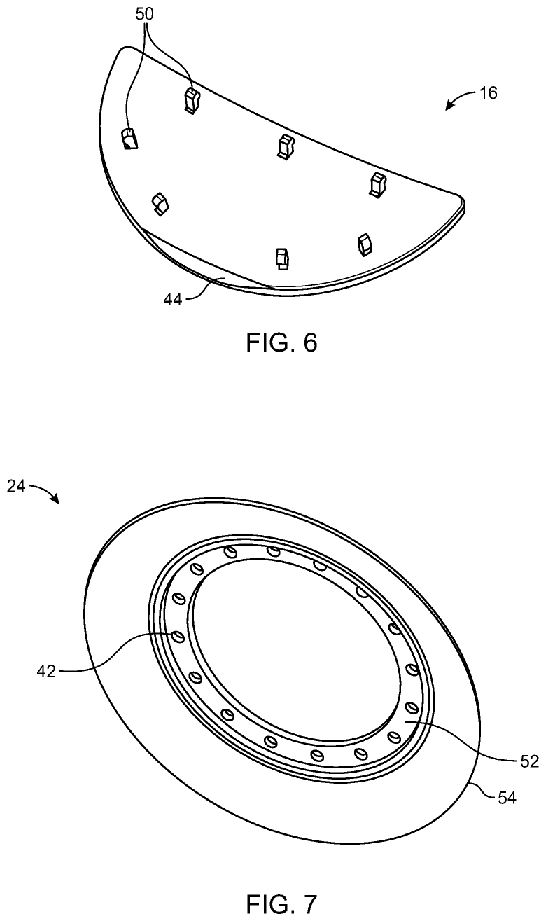

In embodiments, the top housing portion 28 may have at least one finger tab 44 (hereinafter “finger tab 44”) as shown in FIG. 4 that may be sized, shaped, configured, and/or adapted to facilitate easy and/or quick removal of the lid 16 from the housing body 14. In embodiments, the finger tab 44 may receive at least one fingertip of a user that is removing the lid 16 from the top housing portion 28. Moreover, the finger tab may alternatively be disposed or provided on the lid 16 as shown in FIG. 6. In one embodiment, the finger tab 44 may be provided on both the lid 16 and the top housing portion 28.

FIG. 5 shows a top surface 46 of the lid 16 wherein an outer perimeter of the lid 16 has a semi-circular shape. However, in other embodiments, the outer perimeter of the lid 16 have a non-circular shape. In those embodiments, the non-circular shape may be any two-dimensional geometric shape, such as, for example, triangle, square, rectangle, and/or polygon.

FIG. 6 shows a bottom surface 48 of the lid 16 that has a plurality of snap ribs 50 (hereinafter “ribs 50”) for engaging the top housing portion 28 such that the ribs 50 may connect, attach, fasten, and/or secure the lid 16 to the housing body 14 in fluid- or liquid-proof manner. The ribs 50 extend outwardly away from the bottom surface 48 of the lid 16 and are sized, shaped, configured, and/or adapted to engage one or more top or outer surfaces on the top housing portion 28 for connecting, attaching, and/or fastening the lid 16 to the top housing portion 28. In embodiments where the door seal 40 is disposed or provided on the lid 16, the door seal 40 may encircle the ribs 50 and/or may be adjacent with respect to the outer perimeter of the lid 16. It should be understood that any conventional retaining means may be employed for the closure of the lid 16.

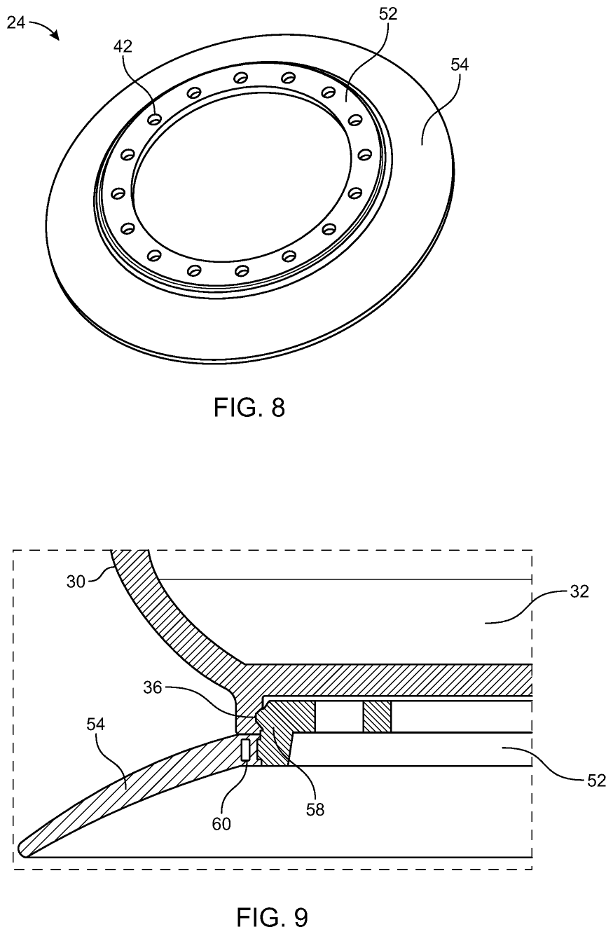

FIGS. 7 and 8 show bottom and top views, respectively, of the mounting ring 24 which has an inner ring 52 that is encircled by an outer skirt 54 such that the outer circumference of the inner ring 52 may contact inner surfaces of the outer skirt 54. The inner ring 52 may be made of a first material and the outer skirt 54 may be made of a second material. The first material may be more rigid than the second material and the second material may be softer than the first material. In embodiments, the second material of the outer skirt 54 may be elastomeric material. The inner ring 52 may comprise the perforations 42 for connecting, attaching, and/or fastening the sponge 26 to the mounting ring 24.

In embodiments, the top of the inner ring 52 may have at least one engagement rim, collar, rib, or ring 56 (hereinafter “engagement ring 56”) sized, shaped, configured and/or adapted to be insertable into at least one receiving groove 58 disposed or provided on the bottom housing 30 such that the mounting ring 24 is connected, attached, and/or fastened to the housing body in snap-fitting manner, as best shown in FIGS. 9-11. As a result of interactions between the engagement ring 56 and the receiving groove 58, the sponge 26 connected to the mounting ring 24 may be connected, attached, and/or fastened to the dispenser 12 in a snap-fitting manner. Additional, at least one overmold interlock 60 may be disposed between and/or provided by the outer skirt 54, the inner ring 52, and the bottom housing portion 30 to firmly secure the dispenser 12 to the mounting ring 24 and/or the sponge 26, as shown in FIG. 9. In an embodiment, the at least one overmold interlock 60 may increase fastening strength between dispenser 12 and the mounting ring 24 such that the dispenser 12 and the mounting ring 24 may be inseparable without aid or assistance of a prying tool or the like.

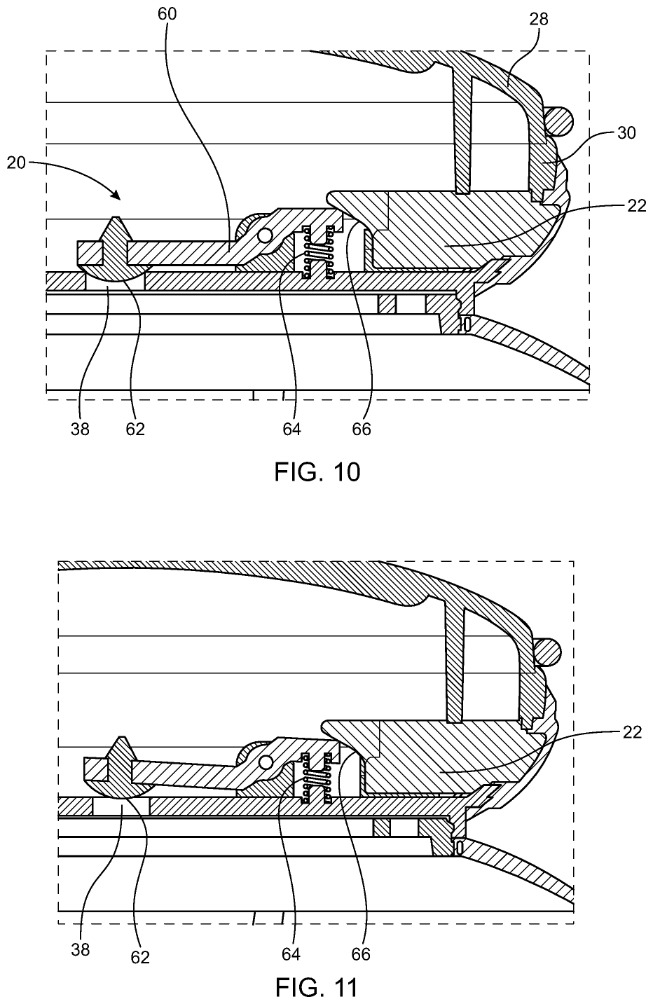

FIGS. 10 and 11 show the mechanism 20 and/or the button 22 moving from a first or closed position to a second or opened position, respectively. In embodiments, the mechanism 20 remains in the first or closed position normally until activation of the button 22. The dispenser opening 38 remains closed and/or sealed while the mechanism 20 remains in the first or closed position. In embodiments, activation and/or compression of the button 22 moves the mechanism 20 to the second or opened position until deactivation of the button 22. In the second or opened position, the dispenser opening 38 is open and/or unsealed such that the resulting mixture may pass through the dispenser opening 38 outwardly and away from the bottom housing portion 30. If sponge 26 is connected to the dispenser, then activation and/or compression of the button 22 opens the dispenser opening 38 such that the resulting mixture may contact and/or enter into the sponge 26 for application to skin and/or one or more surfaces.

As shown in FIG. 10, the mechanism 20 further comprises a lever 60 having a dispenser seal 62 disposed at a first end of the lever 60 and/or a spring 64 under pre-load (hereinafter “spring 64”) disposed at an opposite second end. The lever 60 has a fulcrum disposed between the first and second ends of the lever. In embodiments, and the fulcrum of the lever 60 is disposed or provided at a location or position that is closer to the spring 64 and/or the button 22 than to the dispenser seal 62.

When in the first or closed position, the button 22, which may be spring-loaded, is retracted from pushing and/or interacting with the lever 60, which is disposed adjacent to an interior surface 66 of the button 22. A spring force of the spring 64 adjacent to the interior surface 66 of the button 22 may firmly compress the dispenser seal 62 against edges of the dispenser opening 38 such that dispenser opening 38 is closed in a fluid- or liquid-proof manner. Being under pre-load, the spring 64 maintains the dispenser seal 62 and/or the mechanism 20 in the first or closed position until activation and/or compression of the button 22. In an embodiment, the dispenser seal 62 may be made out of polymeric-based material, such as, for example, rubber.

Upon activation and/or compression of the button 22, the interior surface 66 of the button 22 applies force onto and/or contacts the adjacent second end of the lever 60, pushes the adjacent second end of the lever 60 downward towards the spring 64, compresses the spring 64, and/or moves or lifts the dispenser seal 62 away from the dispenser opening 38 for moving the mechanism 20 to the second or open position, as shown in FIG. 11. In other words, upon compression of the button 22, the button 22 and/or the lever 60 may overcome the spring force of spring 64 such that the dispenser seal 62 may raise and/or separate from the dispenser opening 38 for moving the mechanism 20 to the second or open position. Once in the second or open position, the resulting mixture may freely flow out of the dispenser opening 38 onto or into the sponge 26.

In embodiments, the cleanser formulation is preferably a dry and/or powdered composition that may be pourable into the basket 34 of the dispenser 12 for mixing with the liquid, as illustrated in FIGS. 12 and 13. As an alternative, a powdered or dry cleanser formulation in the form of a compacted solid mass, such as a cake, tablet or pearls, may be used, so long as such will dissolve in or become suspended in liquid to form a low viscosity cleanser liquid and generally act with the attributes of a powder cleanser in the context of the invention. It is noted that the cleanser formed when the cleanser formulation is mixed with liquid which fills or substantially fills the interior volume of the dispenser has a viscosity which is close to or slightly above that of water, and is therefore preferably in the range of about 1 cps to less than 1000 cps, preferably about 50 to about 500 cps, more preferably about 100 to about 400 cps, and most preferably about 200 to about 300 cps. In embodiments, the lid 16 may be connected, attached, fastened, and/or hinged to the top housing portion 28, as shown in FIGS. 12 and 13. After the dry and/or powdered composition is received in the basket 34, the liquid may be added, the lid may be closed and/or secured to the dispenser 12, and/or the dispenser 12 may be gently shaken by a user such that the dry and/or powdered composition and the liquid mix to prepare and provide the resulting mixture. At the time of use, the user may compress or activate the button 22 and the resulting mixture may flow from the interior 32 of the dispenser, past the dispenser seal 62, through the dispenser opening 38, and into the sponge 26. The user may apply the resulting mixture onto a surface to be cleaned and the sponge 26 may apply the necessary force to cleanse the surface.

In embodiments, the dispenser 12 and/or the button 22 may have an ergonomic design and/or shape to facilitate easy and/or pain manipulation by a hand of the user. The ergonomic design and/or shape may allow the hand of the user to hold the dispenser and/or to push the button 22 without adding discomfort to fingers, hands, and/or arms of the user. As a result, the system 10 may be held in the hand of the user for longer durations of time with improved ease and/or an improved comfort to the fingers, hands, and/or arms.

In embodiments, the cleanser formulation may be one or more concentrated body wash compositions in the form of a dry/powder composition 70 as shown in FIGS. 12 and 13. Powdered particles of the dry/powder composition 70 may be determined by the skilled person to achieve the goals set out for the invention. However, the powdered particles may have an average particle size, for example between about 25 microns to about 500 microns, preferably between about 100 and about 400 microns and more preferably between about 200 and about 300 microns, and the porous barrier 34 may comprise meshing that is sized, shaped, configured and/or adapted to permit passage of particles having particles sizes the same as or less than the first average particle size. Alternatively, the pore size of the porous barrier may be smaller than the particle size of the dry powder, but nevertheless may allow passage of a cleanser formulation formed by dissolution or partial dissolution of the powder in added liquid.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A cleanser dispenser and applicator system comprising:
a dispenser comprising a housing body defining an interior of the dispenser and having a first dispenser opening disposed on a first portion of the housing body;
a porous barrier disposed between the first dispenser opening and the interior of the dispenser, the porous barrier having an average pore size of about 25 μm to about 500 μm;
a closeable lid for sealingly covering the first dispenser opening;
an applicator body defining a cavity therein, the applicator body connected to a second portion of the housing body such that a second dispenser opening of the second portion of the housing body is disposed between the interior of the dispenser and the cavity of the applicator body and provides fluid communication from the interior of the dispenser to the cavity of the applicator body;
a seal operable for opening and closing the second dispenser opening.

2. The system of claim 1, wherein the porous barrier is in the form of a rigid or semi-rigid cage or basket projecting into the interior of the dispenser.

3. The system of claim 1, wherein the second dispenser opening has a diameter between about 2.5 mm to about 10.0 mm.

4. A kit comprising:
the dispenser of claim 1; and
a powdered cleanser composition having an average particle size less than or equal to the maximum pore size of the porous barrier.

5. The kit of claim 4, wherein the powdered cleanser composition, when mixed with water in the interior of the dispenser, has a viscosity of between about 1 cps up to 1000 cps.
